(19) United States
(12) Patent Application Publication
(10) Pub. No.: US 2020/0413074 A1
(43) Pub. Date: Dec. 31, 2020

(54) SYSTEM AND METHOD FOR SUPPORTING VIDEO CODING BASED ON FAST FEEDBACK

(71) Applicant: SZ DJI TECHNOLOGY CO., LTD., Shenzhen (CN)

(72) Inventors: Ning MA, Shenzhen (CN); Lei ZHU, Shenzhen (CN); Ying CHEN, Shenzhen (CN)

(73) Assignee: SZ DJI TECHNOLOGY CO., LTD., Shenzhen City (CN)

(21) Appl. No.: 17/015,317

(22) Filed: Sep. 9, 2020

Related U.S. Application Data
(63) Continuation of application No. PCT/CN2018/078637, filed on Mar. 9, 2018.

(51) Int. Cl. H04N 19/164; H04N 19/105; H04N 19/172

(52) U.S. Cl. CPC H04N 19/164; H04N 19/172; H04N 19/105

(57) ABSTRACT

Systems and methods can support video coding. The systems can provide technical solutions for improving the coding efficiency, maintaining consistent transmission load and ensuring the quality of media content after transmission, which are key factors for achieving satisfactory user experience. A video encoder can receive, from a receiving device associated with a decoder, feedback information related to receiving encoded data for one or more data units in one or more previous image frames in a video stream. A video decoder can unpack one or more data packets received from a transmitting device associated with a encoder, wherein said one or more data packets contains encoded data for a first data unit in an image frame in a video stream.

### COPYRIGHT NOTICE

A portion of the disclosure of this patent document contains material which is subject to copyright protection. The copyright owner has no objection to the facsimile reproduction by anyone of the patent document of the patent disclosure, as it appears in the Patent and Trademark Office patent file or records, but otherwise reserves all copyright rights whatsoever.

### FIELD OF THE INVENTION

The disclosed embodiments relate generally to video processing, more particularly, but not exclusively, to video coding.

### BACKGROUND

The consumption of video content has been surging in recent years, mainly due to the prevalence of various types of portable, handheld, or wearable devices. Typically, the video data or other media content is encoded at the source into an encoded (compressed) bit stream, which is then transmitted to a receiver over a communication channel. It is desirable to improve the coding efficiency, maintain consistent transmission load and ensure the quality of media content after transmission. This is the general area that embodiments of the invention are intended to address.

### SUMMARY

Described herein are systems and methods that can support video coding. A video encoding system (or encoder) can receive, from a receiving device associated with a decoder, feedback information related to receiving encoded data for one or more data units in one or more previous image frames in a video stream. The system can determine a first reference data unit for a first data unit in an image frame in the video stream based on the received feedback information, and encode the first data unit in the image frame based on the first reference data unit.

Also described herein are systems and methods that can support video coding. A video decoding system (or decoder) can unpack one or more data packets received from a transmitting device associated with a encoder, wherein said one or more data packets contains encoded data for a first data unit in an image frame in a video stream. The system can determine whether the first data unit in the image frame is correctly received based at least on referencing information contained in the one or more data packets, and provide feedback information to the encoder, wherein the feedback information indicates whether or not said first data unit in the image frame is correctly received.

### BRIEF DESCRIPTION OF DRAWINGS

FIG. 1 illustrates a movable object environment, in accordance with various embodiments.

FIG. 2 illustrates an exemplary carrier in a movable object environment, in accordance with various embodiments.

FIG. 3 illustrates an exemplary system for implementing coding and data transmission based on feedback information, in accordance with various embodiments.

FIG. 4 illustrates an exemplary process for supporting feedback based coding at data unit level, in accordance with various embodiments.

FIG. 5 illustrates an exemplary process for data coding, in accordance with various embodiments.

FIG. 6 illustrates an exemplary process for data coding with referencing information, in accordance with various embodiments.

FIG. 7 illustrates an exemplary process for composing a reference frame, in accordance with various embodiments.

FIG. 8 illustrates an exemplary process for generating feedback information, in accordance with various embodiments.

FIG. 9 illustrates an exemplary process for maintaining and synchronizing reference management information, in accordance with various embodiments.

FIG. 10 illustrates a flow chat for supporting video encoding, in accordance with various embodiments.

FIG. 11 illustrates a flow chat for supporting video decoding, in accordance with various embodiments.

### DETAILED DESCRIPTION

The invention is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

The description of the invention as following uses an unmanned aerial vehicle (UAV) as example for a movable object. It will be apparent to those skilled in the art that other types of movable object can be used without limitation.

For video transmission over unreliable channels, e.g. via wireless connection between a UAV and a remote controller, data loss and data errors may occur during data transmission, which can lead to video decoding errors. When data loss and data errors occur, it cannot be foreseen by the transmission device. Therefore, an error recovery mechanism may be needed to correct the detected video data errors. Traditionally, periodic error-tolerant frames or groups of frames are used to correct the transmission error. Such approach may lead to unstable load through the communication channel, which affects the user experience. Also, it may waste the channel bandwidth and reduce the channel utilization rate. For example, using periodic error-tolerant frame or groups of error-tolerant frames may introduce transmission delays or jitters. Additionally, such error recovery mechanism can cause different sections of the frame using different prediction modes, which may contribute to discontinuities and rolling effects in image display (in the case of using error-tolerant frame groups), and breathing effects (in the case of using single error-tolerant intra frame periodically).

In accordance with various embodiments, fast feedback mechanism can be implemented at the data unit level (e.g. for each image slice in an image frame). For example, when an error related to transmitting and receiving an image slice is encountered while coding the image frame, the system can use the latest of all image slices that are correctly received as a reference image slice to ensure that the reference information is closest to the present image frame at the time dimension. Thus, the fast feedback mechanism can reduce the pressure on the communication channel, since there is no need for sending error-tolerant frame (e.g. I-frames) or error-tolerant frame groups. Also, since the reference frame can be composed of the latest received image slices, the system can achieve higher compression efficiency.

In accordance with various embodiments of the present invention, the system can provide technical solutions for improving the coding efficiency, maintaining consistent transmission load and ensuring the quality of media content after transmission, which are key factors for achieving satisfactory user experience.

In accordance with various embodiments of the present invention, a video encoding system (or encoder) can receive, from a receiving device associated with a decoder, feedback information related to receiving encoded data for one or more data units in one or more previous image frames in a video stream. The system can determine a first reference data unit for a first data unit in an image frame in the video stream based on the received feedback information, and encode the first data unit in the image frame based on the first reference data unit.

In accordance with various embodiments of the present invention, a video decoding system (or decoder) can unpack one or more data packets received from a transmitting device associated with a encoder, wherein said one or more data packets contains encoded data for a first data unit in an image frame in a video stream. The system can determine whether the first data unit in the image frame is correctly received based at least on referencing information contained in the one or more data packets, and provide feedback information to the encoder, wherein the feedback information indicates whether or not said first data unit in the image frame is correctly received.

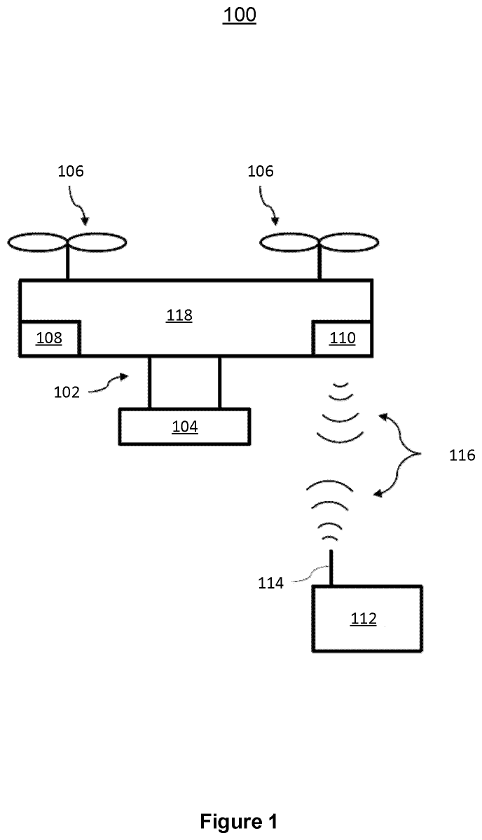

FIG. 1 illustrates a movable object environment, in accordance with various embodiments. As shown in FIG. 1, a movable object 118 in a movable object environment 100 can include a carrier 102 and a payload 104. Although the movable object 118 can be depicted as an aircraft, this depiction is not intended to be limiting, and any suitable type of movable object can be used. One of skill in the art would appreciate that any of the embodiments described herein in the context of aircraft systems can be applied to any suitable movable object (e.g., a UAV). In some instances, the payload 104 may be provided on the movable object 118 without requiring the carrier 102.

In accordance with various embodiments of the present invention, the movable object 118 may include one or more movement mechanisms 106 (e.g. propulsion mechanisms), a sensing system 108, and a communication system 110.

The movement mechanisms 106 can include one or more of rotors, propellers, blades, engines, motors, wheels, axles, magnets, nozzles, animals, or human beings. For example, the movable object may have one or more propulsion mechanisms. The movement mechanisms 106 may all be of the same type. Alternatively, the movement mechanisms 106 can be different types of movement mechanisms. The movement mechanisms 106 can be mounted on the movable object 118 (or vice-versa), using any suitable means such as a support element (e.g., a drive shaft). The movement mechanisms 106 can be mounted on any suitable portion of the movable object 118, such on the top, bottom, front, back, sides, or suitable combinations thereof.

In some embodiments, the movement mechanisms 106 can enable the movable object 118 to take off vertically from a surface or land vertically on a surface without requiring any horizontal movement of the movable object 118 (e.g., without traveling down a runway). Optionally, the movement mechanisms 106 can be operable to permit the movable object 118 to hover in the air at a specified position and/or orientation. One or more of the movement mechanisms 106 may be controlled independently of the other movement mechanisms. Alternatively, the movement mechanisms 106 can be configured to be controlled simultaneously. For example, the movable object 118 can have multiple horizontally oriented rotors that can provide lift and/or thrust to the movable object. The multiple horizontally oriented rotors can be actuated to provide vertical takeoff, vertical landing, and hovering capabilities to the movable object 118. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 118 (e.g., with respect to up to three degrees of translation and up to three degrees of rotation).

The sensing system 108 can include one or more sensors that may sense the spatial disposition, velocity, and/or acceleration of the movable object 118 (e.g., with respect to various degrees of translation and various degrees of rotation). The one or more sensors can include any of the sensors, including GPS sensors, motion sensors, inertial sensors, proximity sensors, or image sensors. The sensing data provided by the sensing system 108 can be used to control the spatial disposition, velocity, and/or orientation of the movable object 118 (e.g., using a suitable processing unit and/or control module). Alternatively, the sensing system 108 can be used to provide data regarding the environment surrounding the movable object, such as weather conditions, proximity to potential obstacles, location of geographical features, location of manmade structures, and the like.

The communication system 110 enables communication with terminal 112 having a communication system 114 via wireless signals 116. The communication systems 110, 114 may include any number of transmitters, receivers, and/or transceivers suitable for wireless communication. The communication may be one-way communication, such that data can be transmitted in only one direction. For example, one-way communication may involve only the movable object 118 transmitting data to the terminal 112, or vice-versa. The data may be transmitted from one or more transmitters of the communication system 110 to one or more receivers of the communication system 112, or vice-versa. Alternatively, the communication may be two-way communication, such that data can be transmitted in both directions between the movable object 118 and the terminal 112. The two-way communication can involve transmitting data from one or more transmitters of the communication system 110 to one or more receivers of the communication system 114, and vice-versa.

In some embodiments, the terminal 112 can provide control data to one or more of the movable object 118, carrier 102, and payload 104 and receive information from one or more of the movable object 118, carrier 102, and payload 104 (e.g., position and/or motion information of the movable object, carrier or payload; data sensed by the payload such as image data captured by a payload camera; and data generated from image data captured by the payload camera). In some instances, control data from the terminal may include instructions for relative positions, movements, actuations, or controls of the movable object, carrier, and/or payload. For example, the control data may result in a modification of the location and/or orientation of the movable object (e.g., via control of the movement mechanisms 106), or a movement of the payload with respect to the movable object (e.g., via control of the carrier 102). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view).

In some instances, the communications from the movable object, carrier and/or payload may include information from one or more sensors (e.g., of the sensing system 108 or of the payload 104) and/or data generated based on the sensing information. The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier, and/or payload. Such information from a payload may include data captured by the payload or a sensed state of the payload. The control data transmitted by the terminal 112 can be configured to control a state of one or more of the movable object 118, carrier 102, or payload 104. Alternatively or in combination, the carrier 102 and payload 104 can also each include a communication module configured to communicate with terminal 112, such that the terminal can communicate with and control each of the movable object 118, carrier 102, and payload 104 independently.

In some embodiments, the movable object 118 can be configured to communicate with another remote device in addition to the terminal 112, or instead of the terminal 112. The terminal 112 may also be configured to communicate with another remote device as well as the movable object 118. For example, the movable object 118 and/or terminal 112 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 118, receive data from the movable object 118, transmit data to the terminal 112, and/or receive data from the terminal 112. Optionally, the remote device can be connected to the Internet or other telecommunications network, such that data received from the movable object 118 and/or terminal 112 can be uploaded to a website or server.

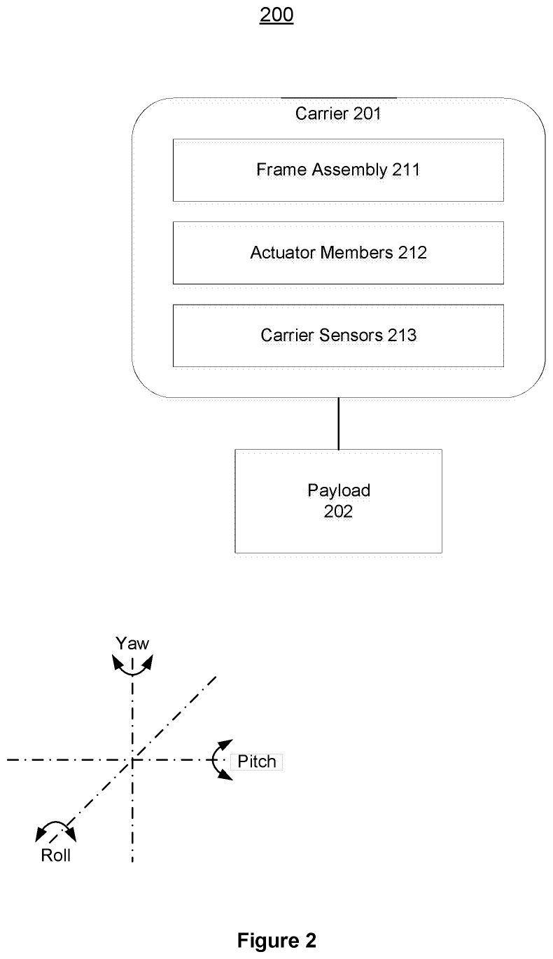

FIG. 2 illustrates an exemplary carrier in a movable object environment, in accordance with various embodiments. The carrier 200 can be used to couple a payload 202 such as an image capturing device to a movable object such as a UAV.

The carrier 200 can be configured to permit the payload 202 to rotate about one or more axes, such as three axes: X or pitch axis, Z or roll axis, and Y or yaw axis, relative to the movable object. For instance, the carrier 200 may be configured to permit the payload 202 to rotate only around one, two, or three of the axes. The axes may or may not be orthogonal to each other. The range of rotation around any of the axes may or may not be limited and may vary for each of the axes. The axes of rotation may or may not intersect with one another. For example, the orthogonal axes may intersect with one another. They may or may not intersect at a payload 202. Alternatively, they may not intersect.

The carrier 200 can include a frame assembly 211 comprising one or more frame members. For example, a frame member can be configured to be coupled with and support the payload 202 (e.g., image capturing device).

In some embodiments, the carrier 201 can comprise one or more carrier sensors 213 useful for determining a state of the carrier 201 or the payload 202 carried by the carrier 201. The state information may include a spatial disposition (e.g., position, orientation, or attitude), a velocity (e.g., linear or angular velocity), an acceleration (e.g., linear or angular acceleration), and/or other information about the carrier, a component thereof, and/or the payload 202. In some embodiments, the state information as acquired or calculated from the sensor data may be used as feedback data to control the rotation of the components (e.g., frame members) of the carrier. Examples of such carrier sensors may include motion sensors (e.g., accelerometers), rotation sensors (e.g., gyroscope), inertial sensors, and the like.

The carrier sensors 213 may be coupled to any suitable portion or portions of the carrier (e.g., frame members and/or actuator members) and may or may not be movable relative to the UAV. Additionally or alternatively, at least some of the carrier sensors may be coupled directly to the payload 202 carried by the carrier 201.

The carrier sensors 213 may be coupled with some or all of the actuator members of the carrier. For example, three carrier sensors can be respectively coupled to the actuator members 212 for a three-axis carrier and configured to measure the driving of the respective actuator members 212 for the three-axis carrier. Such sensors can include potentiometers or other similar sensors. In an embodiment, a sensor (e.g., potentiometer) can be inserted on a motor shaft of a motor so as to measure the relative position of a motor rotor and motor stator, thereby measuring the relative position of the rotor and stator and generating a position signal representative thereof. In an embodiment, each actuator-coupled sensor is configured to provide a positional signal for the corresponding actuator member that it measures. For example, a first potentiometer can be used to generate a first position signal for the first actuator member, a second potentiometer can be used to generate a second position signal for the second actuator member, and a third potentiometer can be used to generate a third position signal for the third actuator member. In some embodiments, carrier sensors 213 may also be coupled to some or all of the frame members of the carrier. The sensors may be able to convey information about the position and/or orientation of one or more frame members of the carrier and/or the image capturing device. The sensor data may be used to determine position and/or orientation of the image capturing device relative to the movable object and/or a reference frame.

The carrier sensors 213 can provide position and/or orientation data that may be transmitted to one or more controllers (not shown) on the carrier or movable object. The sensor data can be used in a feedback-based control scheme. The control scheme can be used to control the driving of one or more actuator members such as one or more motors. One or more controllers, which may be situated on a carrier or on a movable object carrying the carrier, can generate control signals for driving the actuator members. In some instances, the control signals can be generated based on data received from carrier sensors indicative of the spatial disposition of the carrier or the payload 202 carried by the carrier 201. The carrier sensors may be situated on the carrier or the payload 202, as previously described herein. The control signals produced by the controllers can be received by the different actuator drivers. Based on the control signals, the different actuator drivers may control the driving of the different actuator members, for example, to effect a rotation of one or more components of the carrier. An actuator driver can include hardware and/or software components suitable for controlling the driving of a corresponding actuator member and receiving position signals from a corresponding sensor (e.g., potentiometer). The control signals can be transmitted simultaneously to the actuator drivers to produce simultaneous driving of the actuator members. Alternatively, the control signals can be transmitted sequentially, or to only one of the actuator drivers. Advantageously, the control scheme can be used to provide feedback control for driving actuator members of a carrier, thereby enabling more precise and accurate rotation of the carrier components.

In some instances, the carrier 201 can be coupled indirectly to the UAV via one or more damping elements. The damping elements can be configured to reduce or eliminate movement of the load (e.g., payload, carrier, or both) caused by the movement of the movable object (e.g., UAV). The damping elements can include any element suitable for damping motion of the coupled load, such as an active damping element, a passive damping element, or a hybrid damping element having both active and passive damping characteristics. The motion damped by the damping elements provided herein can include one or more of vibrations, oscillations, shaking, or impacts. Such motions may originate from motions of the movable object that are transmitted to the load. For example, the motion may include vibrations caused by the operation of a propulsion system and/or other components of a UAV.

The damping elements may provide motion damping by isolating the load from the source of unwanted motion by dissipating or reducing the amount of motion transmitted to the load (e.g., vibration isolation). The damping elements may reduce the magnitude (e.g., amplitude) of the motion that would otherwise be experienced by the load. The motion damping applied by the damping elements may be used to stabilize the load, thereby improving the quality of images captured by the load (e.g., image capturing device), as well as reducing the computational complexity of image stitching steps required to generate a panoramic image based on the captured images.

The damping elements described herein can be formed from any suitable material or combination of materials, including solid, liquid, or gaseous materials. The materials used for the damping elements may be compressible and/or deformable. For example, the damping elements can be made of sponge, foam, rubber, gel, and the like. For example, damping elements can include rubber balls that are substantially spherical in shape. The damping elements can be of any suitable shape such as substantially spherical, rectangular, cylindrical, and the like. Alternatively or in addition, the damping elements can include piezoelectric materials or shape memory materials. The damping elements can include one or more mechanical elements, such as springs, pistons, hydraulics, pneumatics, dashpots, shock absorbers, isolators, and the like. The properties of the damping elements can be selected so as to provide a predetermined amount of motion damping. In some instances, the damping elements may have viscoelastic properties. The properties of the damping elements may be isotropic or anisotropic. For instance, the damping elements may provide motion damping equally along all directions of motion. Conversely, the damping element may provide motion damping only along a subset of the directions of motion (e.g., along a single direction of motion). For example, the damping elements may provide damping primarily along the Y (yaw) axis. As such, the illustrated damping elements can be configured to reduce vertical motions.

Although various embodiments may be depicted as utilizing a single type of damping elements (e.g., rubber balls), it shall be understood that any suitable combination of types of damping elements can be used. For example, the carrier may be coupled to the movable object using one or more damping elements of any suitable type or types. The damping elements may have the same or different characteristics or properties such as stiffness, viscoelasticity, and the like. Each damping element can be coupled to a different portion of the load or only to a certain portion of the load. For instance, the damping elements may be located near contact or coupling points or surfaces of between the load and the movable objects. In some instances, the load can be embedded within or enclosed by one or more damping elements.

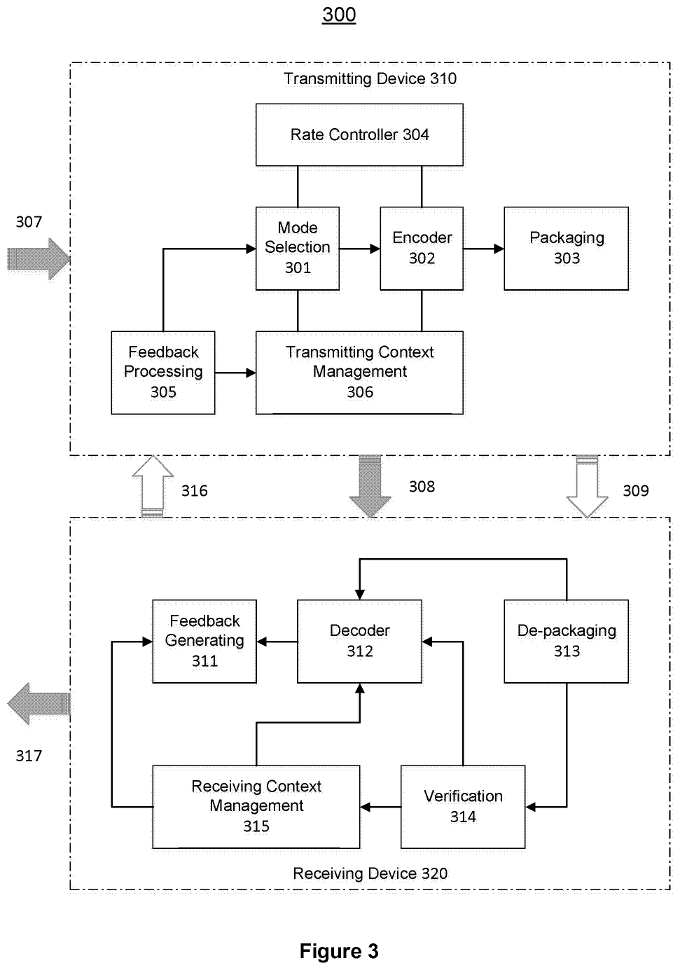

FIG. 3 illustrates an exemplary system 300 for implementing coding and data transmission based on feedback information, in accordance with various embodiments. The system 300 may comprise a transmitting device 310 (such as a transmitting terminal or a transmitter) and a receiving device 320 (such as a receiving terminal or a receiver) that communicate with each other over one or more communication channels (not shown).

The transmitting device 310 can employ an encoder 302. For example, the encoder 302 may be running on the transmitting device 310 or running on a different device that is connected to the transmitting device 310. The encoder 302 can be configured to encode (e.g., compress) one or more data units in the input frames 307, e.g. video frames and/or still image frames.

Furthermore, the transmitting device 310 can transmit the encoded data 308, which is generated by the encoder 302, to the receiving device 320 (after packaging 303 the encoded data 308 into one or more data packets). The receiving device 320 can take advantage of a decoder 312 (after de-packaging 313 or unpacking the one or more data packets). The decoder 312 can be configured to decode (e.g., decompress) the received encoded data 308 to generate reconstructed frames 317 (e.g., for display or playback purposes). Additionally, the receiving device 320 can be configured to generate feedback information 316 (e.g. using a feedback generating module 311) based on the receiving status and error state information collected at the receiving device 320. For example, the receiving status and error state information with respect to the encoded data 308 can be maintained in the receiving context management module 315.

In accordance with various embodiments, the receiving device 320 can transmit the feedback information 316 to the transmitting device 310 to improve the efficiency in coding one or more data units in the input frames 307. The transmitting device 310 can be configured to process the received feedback information 316 (e.g. using a feedback processing module 305) and encode one or more data units in the input frames 307 based on the feedback information 316 received from the receiver 320. For example, the feedback processing module 305 can process the receiving status and error state information in the feedback information 316, and maintain such information in the transmitting context management module 306. In some embodiments, the communication channel used for transmitting the feedback information 316 (also referred to as the feedback channel) may or may not be the same as the communication channel used for transmitting the encoded data 308 (also referred to as the data channel).

In various embodiments, data/image coding based on the feedback information can promote efficient, effective, and reliable error recovery at the receiver (e.g., from data loss or decoding error) while minimizing the performance impact of such error recovery, e.g., on the latency and/or quality of video transmission. For example, extra context information provided by the header/tail associated with the encoded data can further improve the overall efficiency of the system.

Some or all aspects of the process 300 (or any other processes described herein, or variations and/or combinations thereof) may be performed by one or more processors onboard the UAV, a payload of the UAV (e.g., an imaging device), and/or a remote terminal. Some or all aspects of the process 300 (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes.

As shown in FIG. 3, the encoder 302 associated with the transmitting device 310 can be configured to encode one or more data units in the input frames 307 and generate encoded data 308, which is transmitted to the receiving device 320. The encoded data 308 may or may not be enclosed with additional header/tail information that may be used to facilitate verification and/or decoding of the encoded data 308. In some embodiments, the encoded data 308 may be encoded based at least in part on the feedback information 316 received from the receiving device 320.

In accordance with various embodiments, the receiving device 320 can be configured to generate feedback information 316. The feedback information 316 may be generated at least partially in response to receiving the encoded data 308. For example, the receiving device 320 received the encoded data 308 may detect an error in verification of the received data. In such a case, the feedback information 316 indicative of a verification error may be generated. In some embodiments, the verification may be based at least in part on header and/or tail information as described herein. As another example, the receiving device 320 may have received the encoded data 308 and verified its integrity/authenticity, but has failed to decode the data properly due to a decoding error. In these cases, feedback information 316 indicative of the verification error and/or the decoding error may be generated. In yet another example, the generation of the feedback information 316 may not be directly responsive to the receiving of the encoded data 308, but may be based on the lack of received data. For example, it may be determined that a packet representing at least a portion of a frame is missing based on the sequence numbers of the packets that have already received. In some embodiments, the generation of the feedback information 316 may be triggered by other events such as a hardware/software failure, a lapse of a timer (e.g., a predetermined amount of time has lapsed since the last time feedback information is generated), a change in receiver environment, a user input, and the like.

In some embodiments, the feedback information 316 can indicate whether an error has occurred at the receiving device 320 and optionally a type of the error. Additionally, the feedback information 316 may include context information at the receiving device 320, such as an identifier of the last image unit (such as the last frame or image slice) or any image unit before the last image unit that was successfully decoded at the receiver. Such context information, combined with the receiving status and error state indicator, can be used by the transmitter to customize the encoding of the next image unit to improve the reliability and efficiency of data transmission. For example, when there is an error at the receiver, context information can be useful for determining a suitable error recovery mechanism at the transmitter, so as to minimize bandwidth and/or changes in bitrate while substantially maintaining the quality of the transmitted bit stream.

As illustrated in FIG. 3, the feedback information 316 can be transmitted to the transmitting device 310. The feedback information 316 can be transmitted at fixed or variable time intervals. The intervals may be mutually agreed upon by the transmitter and the receiver. The intervals may be dynamically determined based on various factors such as channel capacity, the requirement of a transmitter application regarding the promptness of error recovery, error rate (e.g., bit error rate or bit error ratio) within a predetermined period of time, data regarding previous data transmissions, and the like.

In accordance with embodiments, the transmitting device 310 can be configured to determine a mode (e.g. via mode selection 301) for encoding a data unit in an input frame 307 based at least in part on the feedback information 316 received from the receiving device 320. For instance, determining the coding mode may include selecting a coding mode from a plurality of coding modes. In some examples, determining the coding mode may include selecting and/or composing a reference data unit (such as a reference frame) to be used for data encoding.

In some examples, the coding mode may be determined based on a receiving status and error state information included in the feedback information. For example, if an error has occurred, then a coding mode associated with a predetermined error recovery mechanism may be used. In some cases, additional information such as the type of the error and other information may also be used to determine the coding mode. If no error has occurred, then a default coding mode (e.g., an inter-frame mode) may be used. Additionally or alternatively, the mode may be determined based on comparing a data unit identifier (such as a slice identifier) included in the feedback information and the data unit identifier of the current data unit. The comparison result may be used to determine the coding mode, e.g. based on a pre-determined threshold.

In some embodiments, other factors can be used to determine the coding mode, such as characteristics of the communication channel between the transmitter and the receiver (e.g., capacity, noise, and error rate), use case or application-specific requirement at the transmitter and/or receiver, a state at the receiver, a state at the transmitter, and the like.

Once the coding mode is determined, the various data units in an input frame 307 can be encoded according to corresponding coding mode (e.g., a rate controller 304 may be used to control the coding rate according to the selected coding mode). The encoded data 308 can be transmitted to the receiving device 320 in one or more data packets. Optionally, in some embodiments, the encoded data 308 may be packaged with additional metadata information (e.g., header and/or tail information) prior to being transmitted to the receiving device 320. Such metadata information may facilitate efficient verification and/or decoding at the receiving device 320. In some other embodiments, the encoded data 308 may not be packaged with additional metadata information. As shown in FIG. 3, the additional metadata information 309 may be transmitted using a separate channel (such as a channel that is different from the communication channel used for transmitting the encoded data 308).

In accordance with various embodiments, the receiving device 320 can be configured to verify the received encoded data. The verification 314 may be performed based on the metadata information associated with the encoded data and/or the encoded data itself. The verification 314 may include checking the integrity and/or authenticity of the encoded data. In various embodiments, the verification 314 can occur at any suitable point in time and the verification can be performed for at least a portion of the encoded data. For example, the verification 314 can occur with respect to at least a portion of the encoded data before the encoded data is decoded by a decoder at the receiver. Alternatively or additionally, the verification can occur with respect to at least a portion of the decoded data after the decoding.

The decoder 312 associated with the receiving device 320 can be configured to decode the encoded data 308. The decoder 312 can perform the decoding task according to a decoding mode that correspond to the coding mode. For instance, if a data unit is encoded under an intra-frame mode or an intra-unit mode, then the data unit is decoded using only information contained within a frame or a data unit in a frame. In some embodiments, header/tail information associated with the encoded data 308 can be useful for decoding the various data units in the input data frame 307. For instance, the header/tail information may indicate an encoding/decoding type associated with the data unit (e.g., indicating whether an image slice is an I-slice or P-slice). The header/tail information may also indicate an index of a reference data unit relative to the encoded data unit, so that a decoder can look up the reference data unit to decode the encoded data unit. Thus, the decoder 312 can decode the encoded data 308 to reconstruct the various data units in the reconstructed frame 317. In some embodiments, the reconstructed frame 317 may be displayed or played back on the same or a different terminal as the receiver 204.

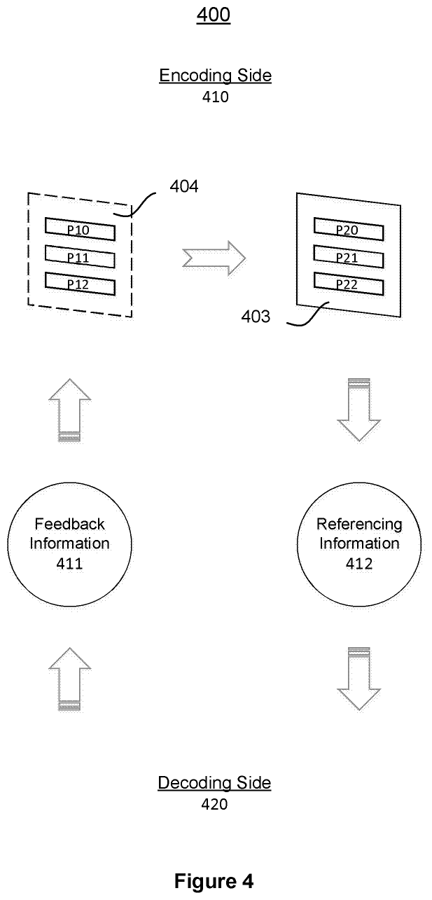

FIG. 4 illustrates an exemplary process 400 for supporting feedback based coding at data unit level, in accordance with various embodiments. As shown in FIG. 4, an encoder at the encoding side 410 can encode various data units in an input frame 403, such as an image frame. In various embodiments, the encoder can refer to information in various reference data units for encoding the different data units in the input frame 403. For example, the input frame 403 can include a plurality of data units, such as image slices: p20, p21, and p22. The input frame 403 can be encoded based on a reference frame 404, which may include a plurality of reference data units such as reference image slices: p10, p11, and p12.

In accordance with various embodiments, the encoding process 400 can be performed at a data unit level (i.e. different data units in the same data/image frame may be encoded using different coding modes). For instance, a data unit in the input frame can be configured to be encoded in an intra-unit mode, i.e. the data unit in the input frame may be encoded without using a reference data unit. On the other hand, other data units in the same input frame can be configured to be encoded in an inter-unit mode, i.e. the data units in the input frame may be encoded using one or more reference data units. For instance, when multiple data units in the image frame refer to reference data units in different image frames that were encoded previously, the different reference data units can be combined into a single reference image frame for taking advantage of various existing coding frameworks and architectures. Alternatively, each data unit in the image frame may be encoded using a particular reference data unit separately without a need for composing an actual reference data frame.

As shown in FIG. 4, the image slices p20 and p22 may be encoded in an inter-unit mode, such as a P-slice mode, using reference image slices p10 and p12 in the reference image frame 404 respectively. (For example, the reference image slices p10 and p12 can be selected from the same image frame that was encoded previously. Alternatively, the reference image slices p10 and p12 can be selected from different image frames that were encoded previously.) On the other hand, an image slice p21 in the image frame 403 can be configured to be encoded in an I-slice mode, i.e. the image slice p21 in the image frame 403 may be encoded without using a reference image slices. (For example, the reference image slice p11 in the reference image frame 404 can be a dummy slice with insignificant values.)

In accordance with various embodiments, such referencing information 412 can be transmitted from the encoding side 410 to the decoding side 420, so that a decoder at the decoding side 420 can decode the received encoded data based on the referencing information 412. Additionally, the decoding side 420 can generate the feedback information 411 and transmit the feedback information 411 to the encoding side 410. For example, the feedback information 411 can be beneficial in determining coding mode and selecting reference data units.

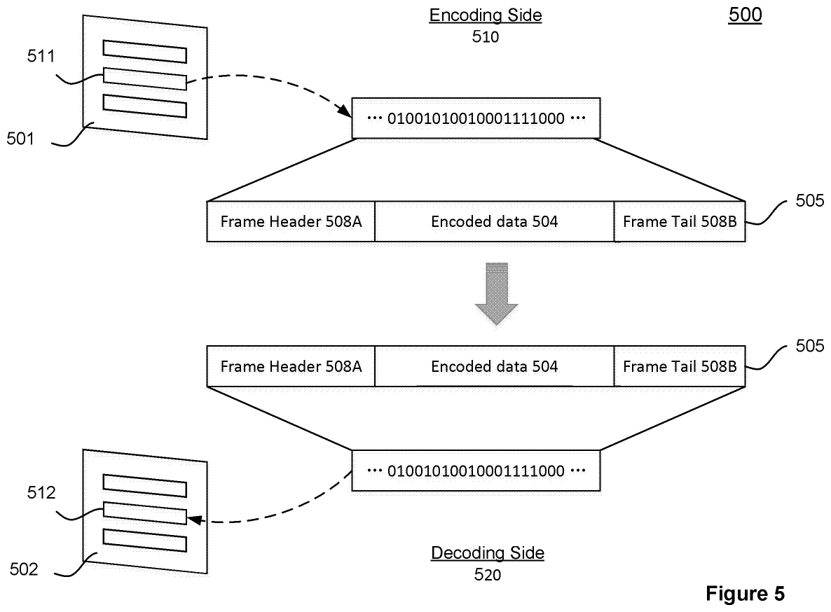

FIG. 5 illustrates an exemplary process 500 for data coding, in accordance with various embodiments. As shown in FIG. 5, a data unit 511 in an input frame 501 may be encoded into encoded data 504, which may comprise a series of bits. In some embodiments, encoding the data unit 511 may include compressing, applying encryption, or otherwise transforming data in the data frame. The encoded data 504 may be packaged into one or more data packets. Each packet 505 may comprise at least a portion of the encoded data 504 and, optionally, metadata 508A and 508B about the encoded data 504. In some embodiments, the metadata 508A and 508B may include an identifier or a sequence number for the packet 505. The packet identifier can be used by the receiver for detecting missing or out of order packets. The packaged data packet(s) 505 can be transmitted over a data communication channel (which may be the same or different from the feedback communication channel) to a receiver.

At the decoding side 520, a decoder may be configured to unpack and verify the received data packet(s) 505. For example, for each data packet 505, the metadata 508A and 508B can be extracted and used for verifying the integrity of the encoded data 504, detecting any error that may have occurred during transmission, and checking whether the data unit 511 received from the encoding side 510 can be reconstructed at the decoding side 520. Also, the decoding side 520 can check whether the frame 501 (including the data unit 511) received from the encoding side 510 can be reconstructed at the decoding side 520. For instance, if one of a plurality of packets for the data unit 511 in the frame 501 is missing, then the frame 502 may not be constructed. As another example, errors can be detected by checking an error detection code associated with the encoded data. In some embodiments, the verification can occur prior to actually decoding the encoded data. Alternatively or additionally, the metadata may be useful for verifying validity of the decoded data after the decoding process.

In some embodiments, the metadata can include header data 508A prefixed before the encoded data 504 and/or tail data 508B appended after the encoded data 504. For example, the header 508A can include fields such as a data unit identifier of the encoded data unit, a type of the encoded data unit (e.g., I-slice, P-slice, B-slice), a reference data unit offset (e.g., from the current data unit identifier), a timestamp (e.g., for when the encoding is done), a frame rate (e.g., frames per second), a data rate or bitrate (e.g., megabits per second), a resolution, and the like. The tail 508B can include fields such as an error detection code or an error correction code of the encoded data unit, a length of the data unit, a tail identifier, and the like. Examples of error detection or correction codes can include repetition codes, parity bits, checksums, cyclic redundancy checks (CRCs), cryptographic functions, and the like. In some embodiments, only the header 508A or the tail 508B may be available. In some embodiments, the header 508A and the tail 508B may include more or less information than described above. For example, the header and/or tail may include a digital signature from a sender of the encoded data and/or a desired feedback transmission interval.

In some embodiments, the error-detection code and data unit length included in the metadata can be used to check the data integrity of the encoded data (e.g., no data corruption or data loss). The data unit identifier included in the metadata can be used to ensure that the data unit has not been previously received by the receiver, and can be used to detect out-of-order data units, and/or to “skipped” data units. The encoding type of the data unit can be used to determine whether additional data is required for the reconstruction of the data unit. For example, an I-slice does not require any additional data to decode the slice, whereas a P-slice requires one or more reference slices. The reference data unit offset can be used to identify the reference data unit required to decode a data unit, such as a P-slice. During the determination of whether the encoded frame can be reconstructed, the reference data unit offset can be used to determine whether the reference data unit is available at the receiver and whether the reference data unit has been reconstructed properly. The received data unit can only be reconstructed if both of the above conditions are satisfied.

In some embodiments, timestamp can be used by the receiver to calculate the time interval between the encoding of the frame at the transmitter and the receipt of the frame at the receiver. The time interval may be useful for determining a condition of the communication channel, a validity of the received data, a feedback transmission interval, and the like. The determination may be based on a comparison between the time interval and one or more predetermined thresholds. The frame rate and the data rate may be used to determine a suitable decoding and/or playback strategy. In some embodiments, a digital signature included in the metadata can be used to authenticate that the encoded data comes from a trustworthy source. In some embodiments, a desired feedback transmission interval included in the metadata can be used by the receiver to determine a suitable feedback transmission interval.

After verification, the encoded data 504 can be decoded by a decoder that corresponds to the encoder generating the encoded data 504. As shown in FIG. 5, the decoded data can be used to reconstruct the data unit 512 in the reconstructed data frame 502. In some embodiments, decoding can include decompressing, decryption, or otherwise reconstructing the frame data. Reconstruction can comprise combining decoded data in a predetermined manner.

In an embodiment, the metadata may be provided as part of the bit stream generated by the encoder. For example, some coding formats according to certain coding standards include a portion for storing such user-defined metadata, in addition to a portion for storing the encoded data. The metadata described herein may be stored as part of such user-defined metadata of the bit stream. The metadata can be extracted by the receiver before decoding of the encoded data, as described elsewhere. Advantageously, in latter embodiment, data transmitted can be handled by a standard-compliant decoder (which supports a coding format with such a user-defined metadata portion), without requiring non-standard handling of metadata outside the bit stream. In an alternative embodiment, the metadata described herein can be provided separately (e.g., in a separate data structure) from the bit stream generated by an encoder. In yet some other embodiments, portion of the metadata may be placed outside the bit stream while other portion of the metadata may be placed within the bit stream.

In some embodiments, the transmission of the metadata, either within the bit stream or outside the bit stream, is configurable by a user or a system administrator. In some example, the transmission of the metadata may be automatically determined based on a type of the codec used to encode/decode the frames. If the codec supports user-defined metadata, then the metadata is transmitted as part of the bit stream. Otherwise, the metadata is transmitted outside the bit stream.

Various coding (e.g., compression/decompression) standards limit the types of reference data units that may be used for encoding/decoding. For example, a coding standard may require that a P-frame may only be encoded using a short-term reference data unit, and does not allow the use of a long-term reference data unit. The techniques described herein allows encoding and decoding using an arbitrary reference data unit, thereby obviating the need for support by the coding standards. To this end, the feedback information from a receiver can specify a desirable reference data unit for encoding a data unit. And the metadata from the transmitter can describe the reference data unit to use for decoding the data unit.

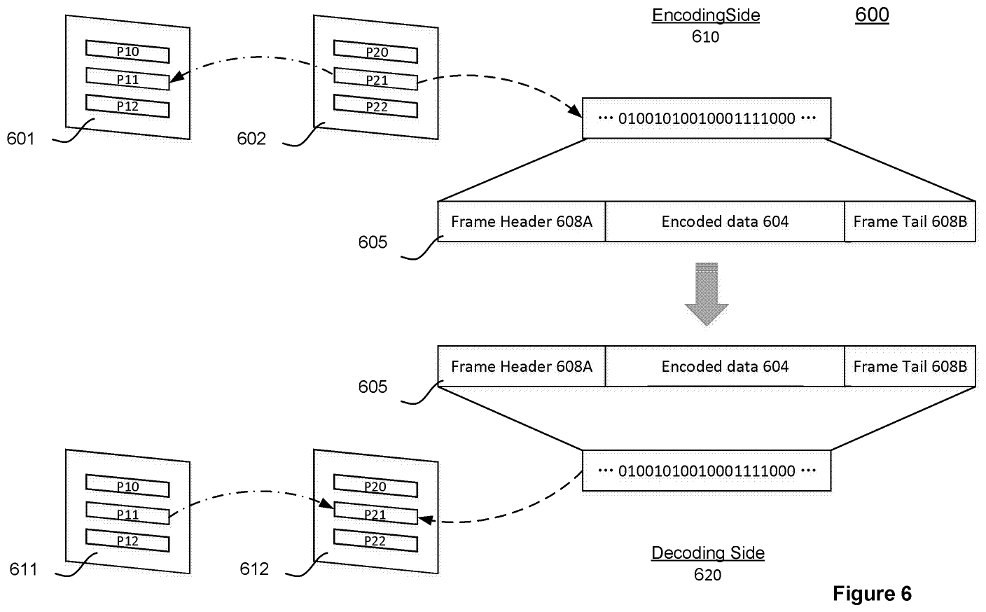

FIG. 6 illustrates an exemplary process 600 for data coding with referencing information, in accordance with various embodiments. As shown in FIG. 6, at the encoding side 610, one or more data units in the input frame 602 can be encoded to generate encoded data 604, which may comprise a series of bits. In some embodiments, encoding the one or more data units in the data frame 602 can include compressing, applying encryption, or otherwise transforming the data in the input frame 602. The encoded data 604 may be packaged in one or more data packets. Each packet 605 may comprise at least a portion of the encoded data 604 and optionally, metadata 608A and 608B about the encoded data 604. In some embodiments, the metadata 608A and 608B also includes an identifier or sequence number for the packet. The packet identifier can be used by the receiver to detect missing or out of order packets. The packaged data packet(s) 605 can be transmitted over a data communication channel (which may be the same or different from the feedback communication channel) to a receiver.

In accordance with various embodiments, the encoding of a data unit in the data frame 601 may depend on a reference data unit. For example, the encoding of an image slice p21 in the image frame 602 may depend on a reference image slice p11 in the image frame 601. The image frame 601 may be encoded immediately before the image frame 602. Alternatively, there may be a pre-determined offset between the image frame 601 and the image frame 602. Thus, at the decoding side 620, the image slice p21 in image frame 612 can be reconstructed based on the corresponding reference image slice p11 in the image frame 611.

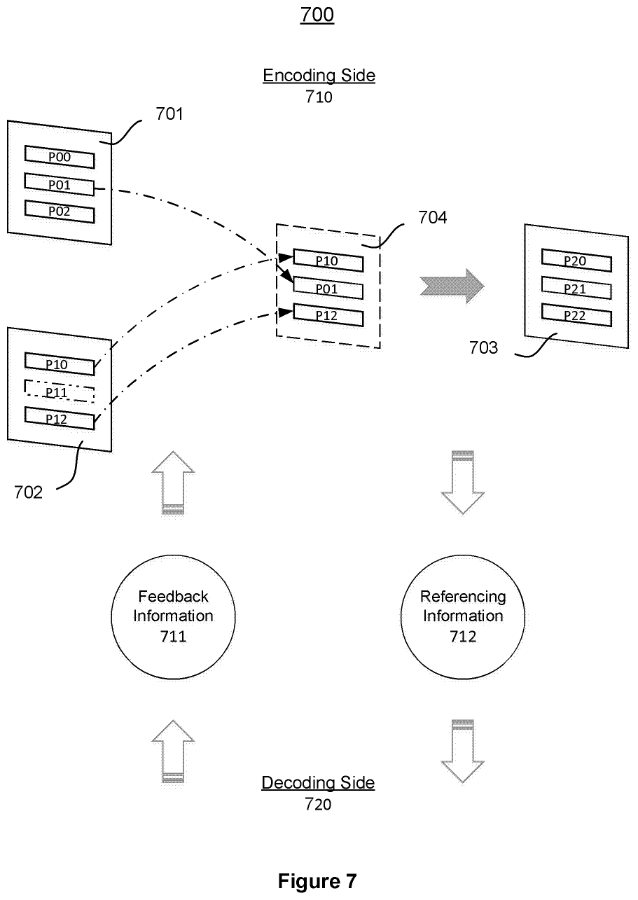

FIG. 7 illustrates an exemplary process 700 for composing a reference frame, in accordance with various embodiments. As shown in FIG. 7, at the encoding side 710, the system can encode an input frame, such as an image frame 703, based on a reference frame 704.

In accordance with various embodiments, the encoding process 700 can be performed on a data unit basis. As shown in FIG. 7, the reference frame 704 may be composed based on previously encoded frames. For example, an image frame 703, which may include a plurality of data units (such as image slices: p20, p21, and p22), can be encoded based on a reference frame 704, which may include a plurality of reference data units (such as image slices: p20, p21, and p22). In various embodiments, the reference frame 704 can be a previously encoded data frame. Alternatively, the reference frame 704 may be composed using a plurality of reference data units that are selected from multiple previously encoded data frames.

In accordance with various embodiments, the selection of the reference data units for composing the reference frame 704 can be determined based on the feedback information 711 received from the decoding side 720. For example, the feedback information 711 may indicate that the data unit p11 in frame 702 is not received correctly and may not be used as a reference data unit. Then, the encoder can reach to a data unit p01 in an earlier data frame, and compose a reference frame 704 comprising reference units p10 and p12 from the frame 702 and a reference unit p01 from frame 701. Subsequently, the referencing information 712 can be transmitted to decoding side 720. Thus, the decoding side 720 can use the referencing information for decoding the encoded data.

In accordance with various embodiments, different data units in the data frame 703 may be encoded using different coding modes. For instance, the data unit p21 in the data frame 703, which may be an image slice, can be configured to encode as an I-slice, i.e. the data unit p21 in the data frame 703 may be encoded without using a reference data unit. In one example, the corresponding reference data unit in the composed reference frame 704 can be a dummy slice (i.e. filed with insignificant values instead of values in image unit p11 or p01).

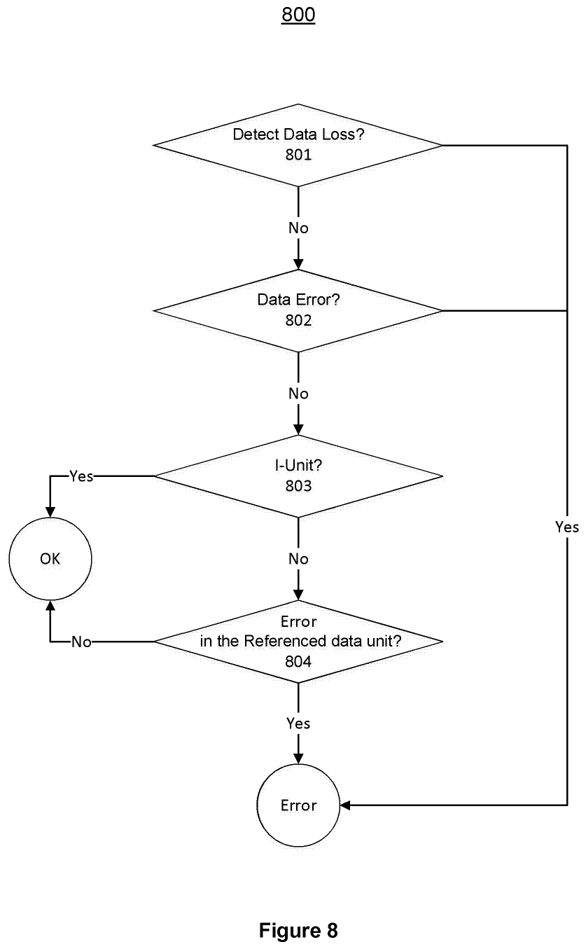

FIG. 8 illustrates an exemplary process 800 for generating feedback information, in accordance with various embodiments. As illustrated in FIG. 8, in order to determine whether a data unit (e.g. an image slice) is received correctly and can be used as a reference data unit, the decoding side can employ the following strategy for generating feedback information.

At step 801, the receiving device on the decoding side can determine whether there is data loss during the data transmission. For example, at the encoding side, each data packet can be assigned with a packet identifier, e.g. using consecutive numbering. In various embodiments, the receiving device can detect a data loss, when a gap is detected in the list of identifiers for the received packets. Thus, the decoding side can determine that the data unit is not correctly received (e.g. by setting the receiving status and error state indicator as “error”), when a data loss is detected.

Otherwise, at step 802, the receiving device can determine whether there is an error in the received data. In various embodiments, the receiving device can use the metadata associated with the encoded data for determining whether there is an error in the received data. For example, the metadata stored in the head or tail section of the data packet can be used for verifying the data integrity in the received data packet. Thus, the decoding side can determine that the data unit is not correctly received (e.g. by setting the receiving status and error state indicator as “error”), when a data error is detected.

Furthermore, at step 803, the receiving device can check whether the decoding of the data unit relies on another data unit, when there is no detected data loss or data error. For example, when the data unit is an intra-unit (e.g. when an image slice an I-slice), the receiving device can determine that the data unit has been correctly received and can be used as a reference data unit (e.g. by setting the receiving status and error state indicator as “ok”).

On the other hand, the decoding of the data unit may rely on another data unit, e.g. when the decoding of a data unit depends on a reference to another data unit, such as a data unit in another data frame. At step 804, the decoding side may determine whether there is an error in the referenced data unit (e.g. using the same or a similar strategy). For example, the receiving side can determine that an error is associated with the present data unit, when the receiving side detects that a data packet contains the referenced data unit is missing, even though the present data unit may be correctly received. Thus, the system can set the receiving status and error state indicator as “error”. Otherwise, the decoding side can determine the data unit is correctly received, e.g. by setting the receiving status and error state indicator as “ok”.

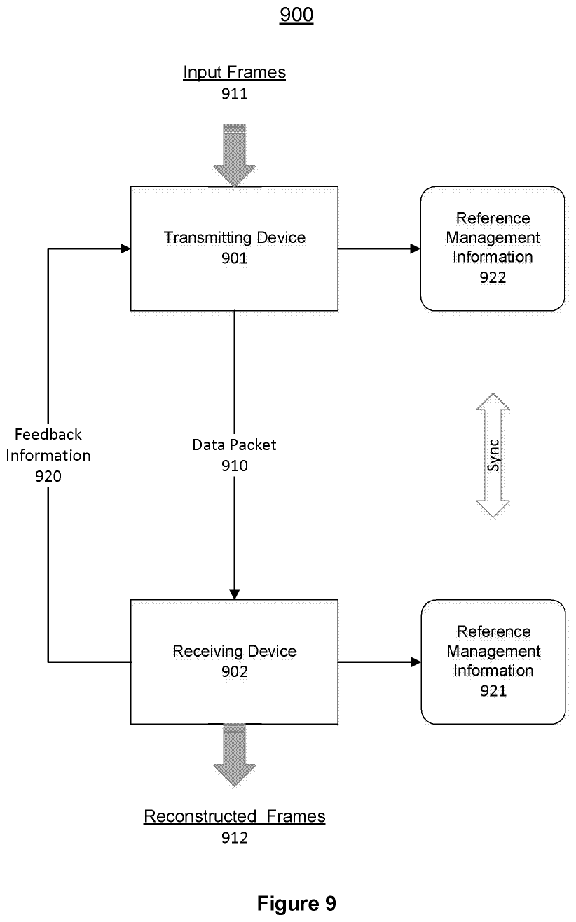

FIG. 9 illustrates an exemplary process 900 for maintaining and synchronizing reference management information, in accordance with various embodiments. As illustrated in FIG. 9, the transmitting device 901 can be configured to encode input frames 911 and transmit the encoded data to the receiving device 902, which can generate reconstructed frames 912. The receiving device 902 may receive the data packets 910 containing encoded data from the transmitting device 901. Based on the receiving status and error state information, the receiving device 902 can generate the reference management information 921. In various embodiments, the reference management information 921 may include identifiers, such as series numbers, for the data units that are correctly received. For example, the data units can be image slices, each of which may be assigned with a unique sequence number at the encoding side. In various embodiments, the identifiers for the data units that are correctly received can be maintained using a data structure, such as a list. For example, the series numbers for the image slices that are correctly received can be maintained in a reference slice management list.

In accordance with various embodiments, the receiving device 902 can generate and transmit the feedback information 920 to the encoding side, such as the transmitting device 901. The feedback information 920 may comprise various reference management information 921, such as the series numbers for all image slices that are correctly received.

In accordance with various embodiments, the transmitting device 901 can extract and maintain the reference management information 922 from the received feedback information 920. In various embodiments, the transmitting device 901 and the receiving device 902 can synchronize the reference management information 921 and the reference management information 922, in a dynamic fashion. For instance, when the receiving device 902 determines that a data unit has been correctly received (and reconstructed), the receiving device 902 can update the reference management information 921 to include an identifier for the data unit. Furthermore, the update to the reference management information 921 can be included in the feedback information 920, which is transmitted to the transmitting device and can be extracted and update the reference management information 922.

In accordance with various embodiments, the transmitting device 901 can compose the reference frame based on the received feedback information 920. For example, the transmitting device 901 may be configured to select the data units that have been correctly received (and reconstructed) to compose the reference frame. In another example, the transmitting device 901 may be configured to select any data unit that are not known as incorrectly received. For example, data units from most recent data frames can be selected to compose the reference frame, before an update to the reference management information 922 is received from the receiving device 902. The second approach can be advantageous in achieving efficiency while assuming a risk that the data unit may actually not be received (or reconstructed) correctly, in which case the transmitting device may need to enact an error recovery mechanism that may involve selecting an older data unit based on the reference management information 922.

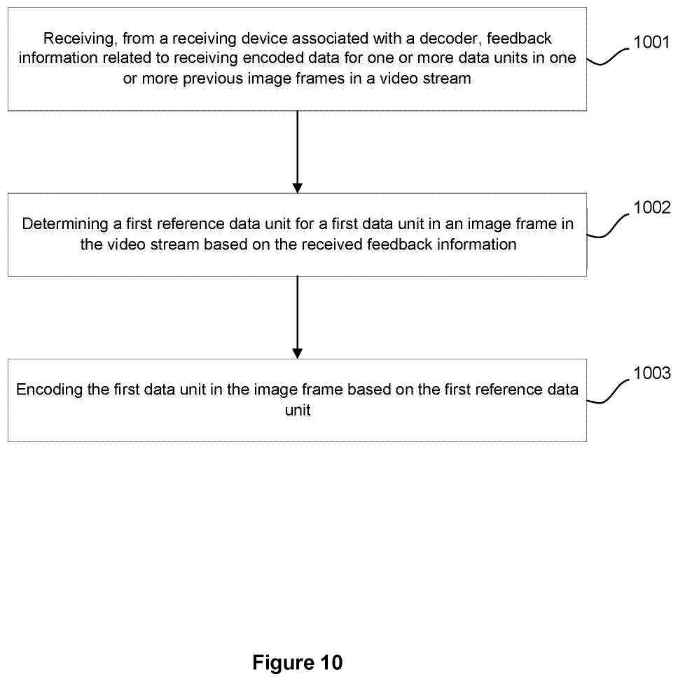

FIG. 10 illustrates a flow chat for supporting video encoding, in accordance with various embodiments. As shown in FIG. 10, at step 1001, a video encoder can receive, from a receiving device associated with a decoder, feedback information related to receiving encoded data for one or more data units in one or more previous image frames in a video stream. At step 1002, the system can determine a first reference data unit for a first data unit in an image frame in the video stream based on the received feedback information. Then, at step 1003, the system can encode the first data unit in the image frame based on the first reference data unit.

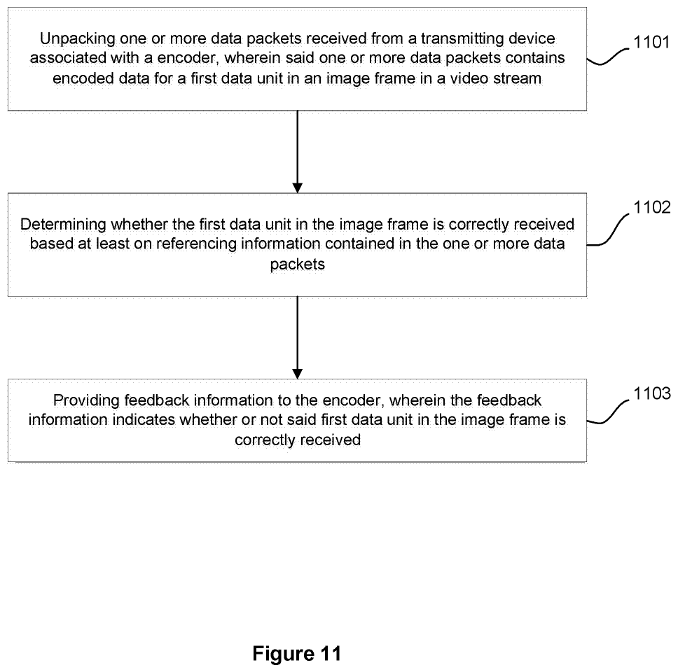

FIG. 11 illustrates a flow chat for supporting video decoding, in accordance with various embodiments. As shown in FIG. 11, at step 1101, a video decoder can unpack one or more data packets received from a transmitting device associated with a encoder, wherein said one or more data packets contains encoded data for a first data unit in an image frame in a video stream. At step 1102, the system can determine whether the first data unit in the image frame is correctly received based at least on referencing information contained in the one or more data packets. Then, at step 1103, the system can provide feedback information to the encoder, wherein the feedback information indicates whether or not said first data unit in the image frame is correctly received.

Many features of the present invention can be performed in, using, or with the assistance of hardware, software, firmware, or combinations thereof. Consequently, features of the present invention may be implemented using a processing system (e.g., including one or more processors). Exemplary processors can include, without limitation, one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like.

Features of the present invention can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features of the present invention can be incorporated in software and/or firmware for controlling the hardware of a processing system, and for enabling a processing system to interact with other mechanism utilizing the results of the present invention. Such software or firmware may include, but is not limited to, application code, device drivers, operating systems and execution environments/containers.

Features of the invention may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the invention.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method for video encoding, comprising:
receiving, from a receiving device associated with a decoder, feedback information related to encoded data from one or more-previous image frames in a video stream, each previous image frame comprising at least one data unit;
determining a first reference data unit for a first data unit in an image frame in the video stream based on the received feedback information; and
encoding the first data unit in the image frame based on the first reference data unit.

2. The method of claim 1, wherein the feedback information indicates whether the the at least one data unit is correctly received by the receiver.

3. The method of claim 1, further comprising determining, based on the received feedback information, a second reference data unit for a second data unit in the image frame.

4. The method of claim 3, wherein the first reference data unit is selected from a first previous image frame in the video stream and the second reference data unit is selected from a second previous image frame in the video stream.

5. The method of claim 4, wherein the feedback information indicates that at least one data unit in the first previous image frame corresponding to the second data unit in the image frame is not received correctly.

6. The method of claim 4, further comprising:
composing a reference frame comprising the first reference data unit and the second reference data unit; and
encoding the image frame based on the reference frame.

7. The method of claim 3, wherein at least one data unit in the image frame is encoded without a reference data unit.

8. The method of claim 1, further comprising packaging encoded data for the first data unit in the image frame into at least one data packet.

9. The method of claim 8, wherein the at least one data packet is associated with an identifier, which is used by the receiving device to generate the feedback information.

10. The method of claim 1, wherein the first data unit in the image frame is an image slice, and the first reference data unit is a reference image slice in a previous image frame in the one or more previous image frames in the video stream.

11. A video encoding system, comprising:
a memory that stores one or more computer-executable instructions; and
one or more processors configured to access the memory and execute the computer-executable instructions to perform steps comprising:
receiving, from a receiving device associated with a decoder, feedback information related to encoded data from one or more-previous image frames in a video stream, each previous image frame comprising at least one data unit;
determining a first reference data unit for a first data unit in an image frame in the video stream based on the received feedback information; and
encoding the first data unit in the image frame based on the first reference data unit.

12. The system of claim 11, wherein the feedback information indicates whether the at least one data unit is correctly received by the receiver.

13. The system of claim 11, the steps further comprising determining, based on the received feedback information, a second reference data unit for a second data unit in the image frame.

14. The system of claim 13, wherein the first reference data unit is selected from a first previous image frame in the video stream and the second reference data unit is selected from a second previous image frame in the video stream.

15. The system of claim 14, wherein feedback information indicates that at least one data unit in the first previous image frame corresponding to the second data unit in the image frame is not received correctly.

16. The system of claim 14, the steps further comprise:
composing a reference frame comprising the first reference data unit and the second reference data unit; and
encoding the image frame based on the reference frame.

17. The system of claim 13, wherein at least one data unit in the image frame is encoded without a reference data unit.

18. The system of claim 11, the steps further comprising packaging encoded data for the first data unit in the image frame into at least one data packet.

19. The system of claim 18, wherein the at least one data packet is associated with an identifier, which is used by the receiving device to generate the feedback information.

20.-30. (canceled)

31. A video decoding system, comprising:
a memory that stores one or more computer-executable instructions; and
one or more processors configured to access the memory and execute the computer-executable instructions to perform steps comprising:
unpacking at least one data packet received from a transmitting device associated with an encoder, wherein the at least one data packet contains encoded data for a first data unit in an image frame in a video stream;
determining whether the first data unit in the image frame is correctly received based at least on referencing information contained in the one or more data packets; and
providing feedback information to the encoder, wherein the feedback information indicates whether the first data unit in the image frame is correctly received.

32.-39. (canceled)
